(19) United States
(12) Patent Application Publication
(10) Pub. No.: US 2010/0232605 A1
(43) Pub. Date: Sep. 16, 2010

(54) METHOD AND APPARATUS FOR PROVIDING AND RECEIVING CONDITIONALLY-ACCESSED VARIOUS APPLICATION INFORMATION

(75) Inventor: Young In Kim, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/377,688

(22) PCT Filed: Aug. 17, 2007
(86) PCT No.: PCT/KR2007/003941

§ 371 Date: May 24, 2010

Related U.S. Application Data
(60) Provisional application No. 60/822,723, filed on Aug. 17, 2006.

(51) Int. Cl. H04L 9/00

(52) U.S. Cl. 380/255

(57) ABSTRACT

The present invention provides various types of encrypted application information. An encoding method according to the present invention encrypts application information to be provided through an application service, creates a first service component frame including an ID of the application service and control data used for encryption of the application information, creates a second service component frame including the encrypted application information, organizes a data frame with the created first and second service component frames, and transmits the organized data frame.

### 1. TECHNICAL FIELD

The present invention is related to a method and an apparatus for providing various application information such as public transportation information or information necessary for vehicle operation on the road and using the provided information.

### 2. BACKGROUND ART

Today, with the advancement of digital signal processing and communications technology, radio and TV broadcast signals are provided gradually in the form of digital data. As signals are provided in a digital form, a variety of information such as news, stock, weather, and traffic information are now supplementing TV or radio broadcasting signal.

In particular, necessity for road traffic information due to the increment of the number of vehicles in downtown areas and the number of vehicles during holidays and necessity for public transportation information to facilitate the use of public transportation by citizens are constantly increasing. Accordingly, methods for providing traffic information or bus service information as auxiliary information via satellite, terrestrial broadcast, or mobile communications network are under development. As a matter of course, methods for providing various application information such as obstacle information on the road and parking lot information in a particular area are also under development in addition to the above.

Such contents are provided either through separate carriers (which imply information transmitters) or through an identical carrier. FIG. 1 illustrates a method for providing different application information through the same carrier, where the information can be congestion and travel-time (CTT) information 10 or road traffic message (RTM) information 11. A data stream received from a single carrier is transferred in a form that each data frame belonging to the data stream includes one or more than one type of TPEG message. A service component identifier (SCID: Service Component ID) is coded into each service component frame within a single frame.

Accordingly, a terminal decoding information composed as above and provided through a single carrier uses information decoded from TPEG-CTT message 10 to display transit information on the road and uses information decoded from TPEG-RTM message 11 to display information about road conditions such as obstacles on the road. As a matter of course, to display different application information such as bus service information, TPEG BSI (Bus Service Information) message associated therewith is utilized.

Since various application information provided in the above manner requires high cost and lots of effort in obtaining, constructing, and running the information, however, part of the invested cost can be imposed on the user who makes actual use of the corresponding application information. Instead, the user may be charged the cost of using the corresponding application information only for more advanced application information. For this purpose, it is necessary to configure various application information provided as above so that part or all of the information is conditionally-accessible—that is, only the users qualified for particular conditions can access application information.

### 3. DISCLOSURE OF THE INVENTION

The objective of the present invention is to provide a method and an apparatus for making a variety of application information conditionally-accessible.

One method for encoding information according to the present invention comprises encrypting application information that is to be provided through an application service, creating a first service component frame including control data used for encryption of the application information and identification information of the application service and creating a second service component frame including the encrypted application information, and composing a data frame including the first service component frame and the second component frame.

One method for providing the user with information according to the present invention comprises extracting a data frame from received signals, from the extracted data frame, extracting a first service component frame including information necessary for using information service and from the extracted first component frame, extracting identification information of an application service and decryption-related control data, and extracting from the extracted data frame a second service component frame including information of an application service designated by the identification information and decrypting data of the extracted second service component frame based on the decryption-related control data.

In one embodiment according to the present invention, the first service component frame also includes an indicator indicating whether the application information has been encrypted and the encryption method in case of encryption.

In one embodiment according to the present invention, data of the second service component frame are encrypted or decrypted from result values obtained by using the control data as an input argument of a given decryption function.

In one embodiment according to the present invention, a terminal receiving application information contained in the application service obtains the decryption function through a path different from a signal path through which application information is received.

In one embodiment according to the present invention, the different path is either a wireless mobile communications network or a wired communications network.

In one embodiment according to the present invention, the control data consists of a first word and a second word independent of each other.

In one embodiment according to the present invention, the second word comprises two words of the same function but with different time points of application and one of the two is used for current encryption or decryption and the other is used for the next encryption or decryption.

In one embodiment according to the present invention, a first one of the two is applied to the second service component frame and a second word is applied to the next second service component frame.

In another embodiment according to the present invention, change of applications between the two words is specified by information contained in the first service component frame.

In one embodiment according to the present invention, the value of a service component identifier to identify the first service component frame is zero.

In one embodiment according to the present invention, information contained in the second service component frame is one from among status information such as road obstacles, service information of a long-distance transportation means, parking lot information, road congestion information, weather information, bus service information, local area information, and news information.

### 4. BRIEF DESCRIPTION OF THE DRAWINGS

FIG. 1 illustrates a transfer format of different types of application information provided by the same carrier;

FIG. 2 illustrates a simplified structure of a network that provides conditionally-accessed application information according to the present invention;

FIG. 3 illustrates a structure of an encryption system for application information according to one embodiment of the present invention;

FIG. 4A illustrates a relationship between a structure of a frame carrying application information and a component frame of service & network information carried by the frame;

FIG. 4B illustrates syntax showing a structure of a component frame of service & network information of FIG. 4A;

FIG. 4C illustrates syntax showing a structure in which information about service table guide is carried by SNI component of FIG. 4B;

FIG. 4D illustrates syntax showing a structure in which information related with encryption of application information is carried by SNI component of FIG. 4B according to one embodiment of the present invention;

FIG. 5 illustrates application information, structure of encryption information of the information, and the corresponding transfer format according to one embodiment of the present invention;

FIG. 6 illustrates a block diagram of a terminal that receives application information transmitted from an application information providing server according to one embodiment of the present invention;

FIG. 7 illustrates AID assigned to each application service;

FIG. 8 illustrates a structure where the terminal of FIG. 6 decodes and stores bus service information that is one type of encrypted application information; and

FIG. 9 illustrates a procedure of displaying application information obtained from decryption and decoding on a screen at the request of the user.

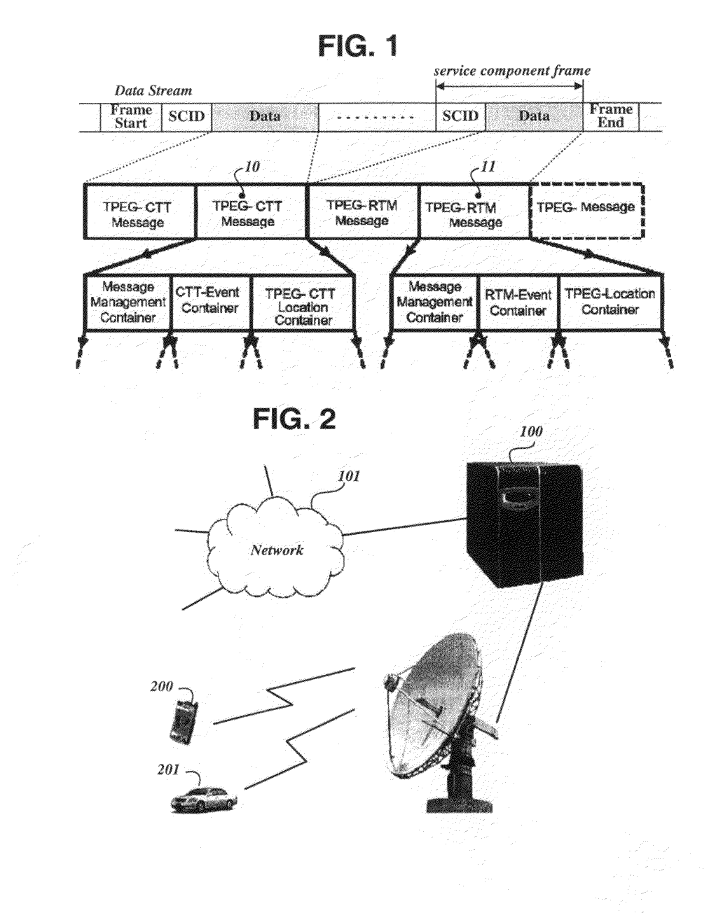

### 5. BEST MODE FOR CARRYING OUT THE INVENTION

Hereinafter, according to the present invention, preferred embodiments will be described in detail with reference to appended drawings.

FIG. 2 illustrates a simplified structure of a network that provides conditionally-accessed application information according to the present invention. An application information providing server 100 in a broadcast station classifies and configures information about congestion, road conditions (such as obstacles on the road), parking lot, long-distance transportation means, and the like collected from various sources (e.g., operator input, information received from another server through a network 101 or probe cars) with respect to each application information and transmits the configured information wirelessly so that a navigation terminal installed in a car 201 or portable information terminal 200 can receive the information. Since an information provider (originator) configuring various application information and a transmitter (carrier) that transmits configured information wirelessly can be different from each other, for the purpose of description, each of the above is described separately if found necessary.

The application information providing server 100 can configure the above information by combining with various other application information and associated information such as weather information, local area information, and news information. Alternatively, the application information providing server 100 may provide CTT information only, whereas various other application information can be provided through a different server. In this case, the application information providing server 100, for conditional reception of application information, can receive necessary information (such as a service component ID (SCID) assigned to a service component frame carrying each application information and necessary information for encryption) by requesting the information from other servers. As a matter of course, when the application information providing server 100 also plays a role of a carrier as described below, the necessary information above can be naturally obtained from information received from the corresponding servers (encryption information) and self-created information (such as SCID). On the other hand, even when the application information providing server 100 is not the creator of the corresponding application information, it can directly create encryption information.

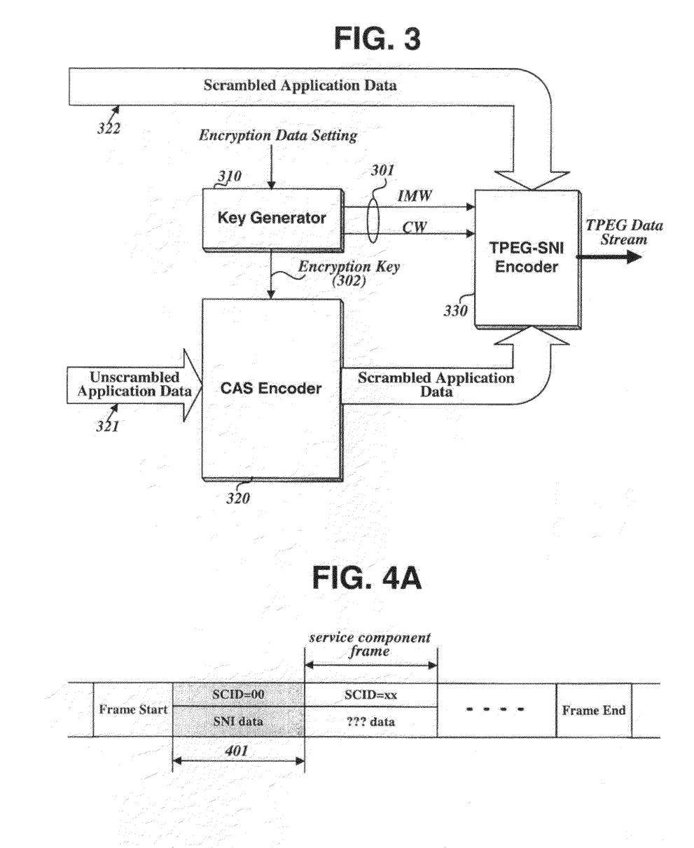

Meanwhile, the application information providing server 100 can carry out encryption in such a way that as for application information of at least one particular type (e.g. congestion information) among application information that the server 100 configures (or that is received from another server), only qualified receivers can decode the information. For this purpose, the application information providing server 100 prepares an encryption system as illustrated in FIG. 3. The system of FIG. 3 can be realized by hardware and/or software.

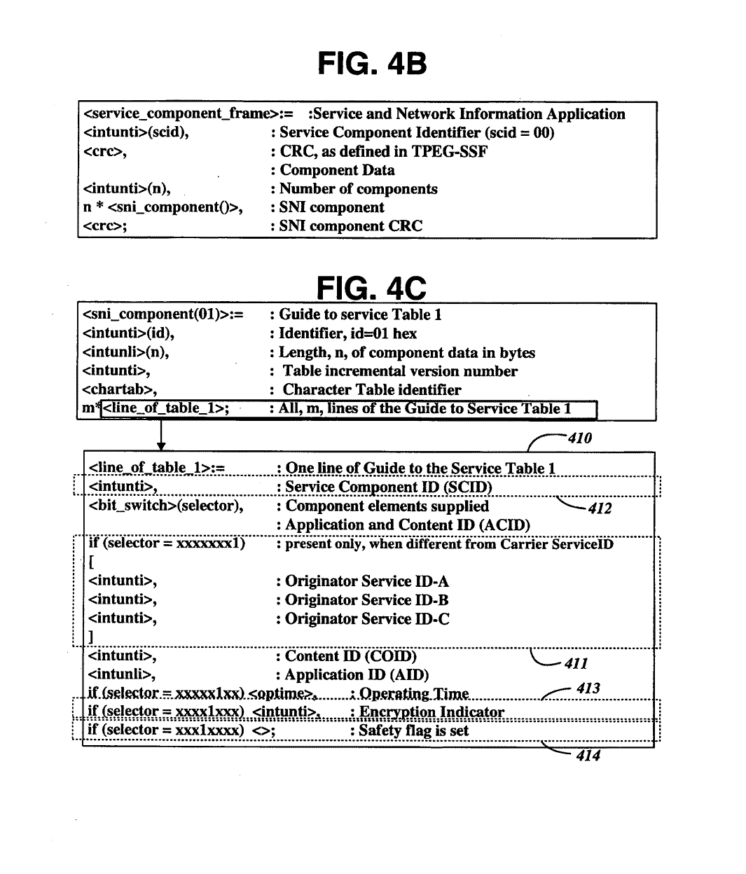

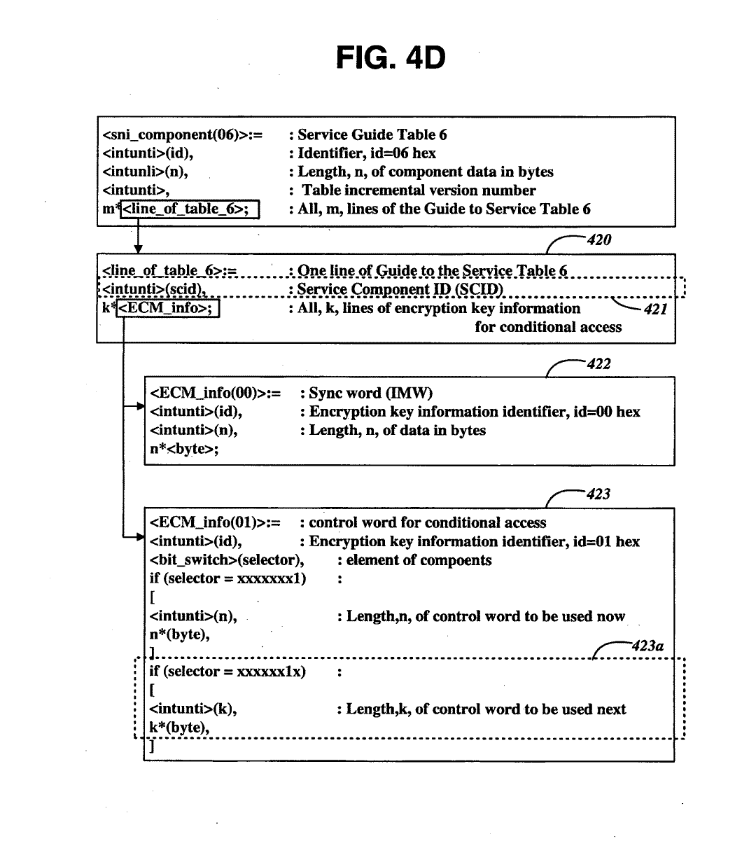

The system of FIG. 3 includes a key generator 310 generating keys used for encryption by using encryption control data 301 set by an operator, a CAS (Conditional Access) encoder 320 encrypting (or scrambling) application information that is input by using the generated encryption keys 302, and a TPEG-SNI encoder 330 encoding the encryption control data 301 and the encrypted application information and/or non-encrypted application information into data frames as shown in FIG. 4A. In an exemplified frame of FIG. 4A, encrypted or non-encrypted application information is contained in a service component frame of SCID=XX. Application data applied to the CAS encoder 320 is the information encoded in compliance with a transfer format of the corresponding application information.

The application information providing server 100 inputs application information 321 designated as conditional reception to the TPEG-SNI encoder 330 after scrambling the information through the CAS encoder 320, whereas as for application information designated as unconditional reception, the server 100 directly inputs the information 322 to the TPEG-SNI encoder 330. As a matter of course, different ways of encryption can be applied to various application information provided in a conditional reception method. That is to say, more than one CAS encoder 320 can be installed for each of application information provided in an unconditional reception method and carry out individual encryption. Multiple CAS encoders can use different encryption keys.

In one embodiment according to the present invention, the encryption control data 301 consists of two independent data, namely a control word (CW) and a sync word (IMW). The key generator 310 of FIG. 3 generates the encryption key 302 through a pre-set function by using the control word and the sync word as an input argument. The control data 301 can be composed of a single data. Also, if necessary, the control data 301 can be composed of more than three independent data. The control data 301 and the function to be set in the key generator 310 either can be set in the application information providing server 100 or can be set as provided by a server that provides application information to be encrypted through the CAS encoder 320.

The application information providing server 100 (i.e., the TPEG-SNI encoder 330), to provide various identifying information about various application information and information related to encryption currently provided by the server itself and/or other servers, includes a service component frame 401 of SNI (Service & Network Information) data whose SCID illustrated in FIG. 4A is 0 in the data frame and thus transmits the data frame. The SNI service component frame 401 has a structure as shown in FIG. 4B and includes more than one SNI component that carries information necessary to use various application services currently provided. Among the SNI components, a component of an identifier 0x01 includes a guide for a service table composed according to the syntax as shown in FIG. 4C. As shown in the figure, the service table guide consists of multiple guide elements (line_of_table_{—}1) 410 and each guide element 410 includes a service component ID (SCID), a content ID (COID), and an application ID (AID). The service ID (SID) of an information provider (originator) that composes and provides information (the SID is composed of “SID-A, SID-B, and SID-C”) is included selectively when the service ID is different from that of a carrier that transmits information. A set of identifying information (COID, AID, and SID of an information provider) included in each guide element 410 can uniquely specifies an application information service. In this manner, each guide element 410 delivers SCID information 412 assigned to a service component frame intended for a single application information service.

Meanwhile, each guide element 410 includes an encryption indicator 413 indicating whether the corresponding application information has been encrypted for conditional reception and a safety flag 414 indicating that a safety related message is being transferred to the service of the corresponding information provider. The encryption indicator 413 is designated as, for example, zero when the corresponding application information (that is, application information to be loaded to a service component frame identified by the corresponding service component ID (SCID) 412) is designated as unconditional reception, whereas the encryption indicator 413 is designated as the value specifying the encryption method (relationship between a specifying value and an encryption method is shared with a terminal) when the information is encrypted and thus provided for conditional reception. In other words, the encryption indicator 413 records a value specifying an encryption method that the CAS encoder 320 utilizes with respect to the corresponding application information.

The safety flag has such an implication that a service component frame identified by the corresponding component ID 412 carries only a message informing a service user, for example, a driver of a problem on his or her driving route such as slipperiness of a road surface. Accordingly, the service component frame having an SCID in a guide element to which the flag is assigned is immediately extracted from the data frame of FIG. 4A and notified to the user.

Although SCID is used to designate service component frames for an application information service within a service signal provided by a single carrier, the information of SCID can be employed for service component frames for other application information services as time goes on. In this case, since the value of a set of identifying information (COID, AID, and SID of an information provider) in a service table guide delivered as composed in FIG. 4C is varied according thereto, a terminal can know the SCID assigned to an application information service that the terminal attempts to use based on the information contained in an SNI component.

In the case of an application information service delivered through another carrier, a terminal can know SCID assigned to an application information service that the terminal attempts to use from the information of an SNI component being transferred through a signal for the service and composed as in FIG. 4C.

Besides, the application information providing server 100 includes in an SNI component sequence composed by the server 100 an SNI component including another service table guide with an identifier of 0x06, the component being composed according to the 10 syntax such as the one in FIG. 4D. This service table guide is provided for conditional reception, being composed of multiple guide elements (line_of_table_{—}6) 420 as shown in the figure and encryption information for conditional reception is loaded into each guide element 420. In one embodiment according to the present invention, encryption information is recorded in each guide element in the form of two ECM components 422, 423 and along with the encryption information, a service component ID (SCID) 421 assigned to the application information to which the encryption information is applied. Since each guide element 420 can assign a unique service component ID, different encryption information can be provided for each of application information.

In one embodiment according to the present invention, as shown in FIG. 4D, two independent data, namely, a sync word (IMW) and a control word (CW) of the encryption control data 301 set in the key generator 310 of FIG. 3D are loaded respectively into the ECM components 422, 423 with identifiers 0x00 and 0x01.

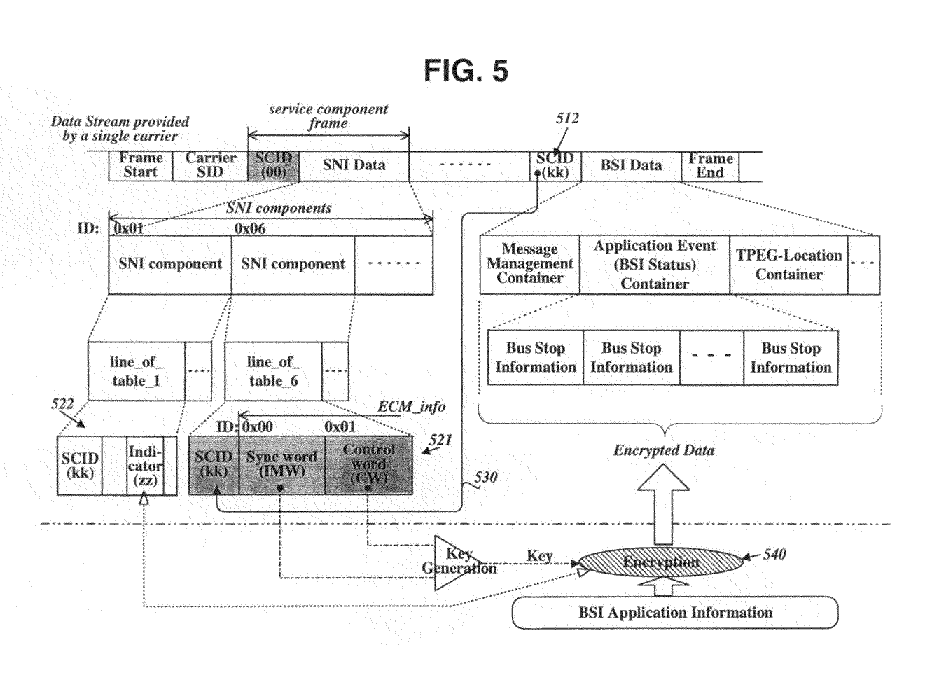

In one embodiment according to the present invention, the control word can be changed any time. To this end, the next control word 423A can be loaded into an ECM component with an identifier 0x01 into which a control word is loaded. Change of application between a current control word and the next control word (in terms of encryption and decryption) can be determined with respect to a service component frame. For example, if a current control word has been used for application information contained in a certain service component frame, the next control word is applied to the application information loaded to the next following service component frame. FIG. 5 illustrates a method for composing and providing conditionally accessed application information according to one embodiment of the present invention. To describe the illustrated composition of information, application information about bus service information is encrypted 540 and the encrypted application information is loaded into a service component frame with an identifier ‘kk’. A sync word and a control word used for generating an encryption key used for the encryption are contained in a guide element 521 in an SNI component with an identifier 0x06. An identifier ‘kk’ 512 assigned to a service component frame carrying encrypted application information is also contained in the guide element 521 and thus provided. A value (‘zz’) indicating a method for the encryption 540 is recorded 541 in an encryption indicator (413 of FIG. 4C) within a guide element 522—contained in an SNI component of an identifier 0x01—storing information related to access and identification of application information about bus service, and thus transferred.

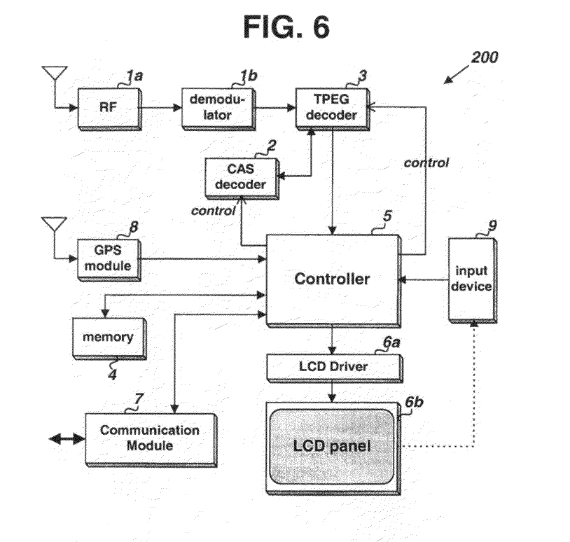

FIG. 6 illustrates a block diagram of a terminal that receives application information composed as described above and transmitted from the application information providing server 100 according to one embodiment of the present invention. For the purpose of description of the present invention, the terminal 200 of FIG. 6 is so configured that it can receive application information specified as conditional reception. To this end, in addition to the hardware for receiving the above application information, employed is a communication module 7 to get an allowance for conditional reception through a separate communication route. A separate communication route can be either a wired or wireless channel. In case of a wired channel, the communication module 7 connects to a physical signal transfer line, thus connecting to a server through a relevant communication protocol. In case of using a wireless channel, the communication module 7 can be a hardware module capable of connecting to a mobile communication networks accommodating mutual communication.

In addition to the communication module 7, as shown in the figure, the terminal 200 includes a tuner 1A resonating at the required frequency band of a designated application information service and subsequently outputting modulated application information signals, a demodulator 1B outputting application information signals by demodulating the modulated application information signals in a mariner relevant to the signals, a TPEG decoder 3 decoding the demodulated application information signals and acquiring application information, a CAS decoder 2 decrypting encrypted application information input according to the request of the TPEG decoder 3, a GPS module 8 for calculating a current position (i.e., latitude, longitude, and altitude) by receiving signals from a plurality of satellites, a storage means 4 storing a variety of graphic information already and storing necessary information temporarily, an input device 9 receiving the user's input, a controller 5 controlling screen display based on the user's input, current location, and acquired application information, an LCD panel 6B for video display, and an LCD drive 6A feeding driving signals to the LCD panel 6B according to graphic data for display. The input device 9 can be a touch screen equipped on the LCD panel 6B. The terminal 200, in addition to the memory 4, can have non-volatile memory to which an electronic map is recorded.

To use encrypted information received conditionally from application information provided by the method described above, the user first connects through the controller 5 to an authentication server managing approval of conditionally-accessed application information for the communication module 7. The authentication server can be either the application information providing server 100 or a separate server. The authentication server, after a proper user authentication, provides the communication module 7 with decryption information corresponding to the type of the requested application information. The decryption information can be a decryption function, for example. Decryption information received through the communication module 7 is delivered to the controller 5 and the decryption information is set to the CAS decoder 2 by the controller 5.

As to the decryption information, different decryption information can be received with respect to application information.

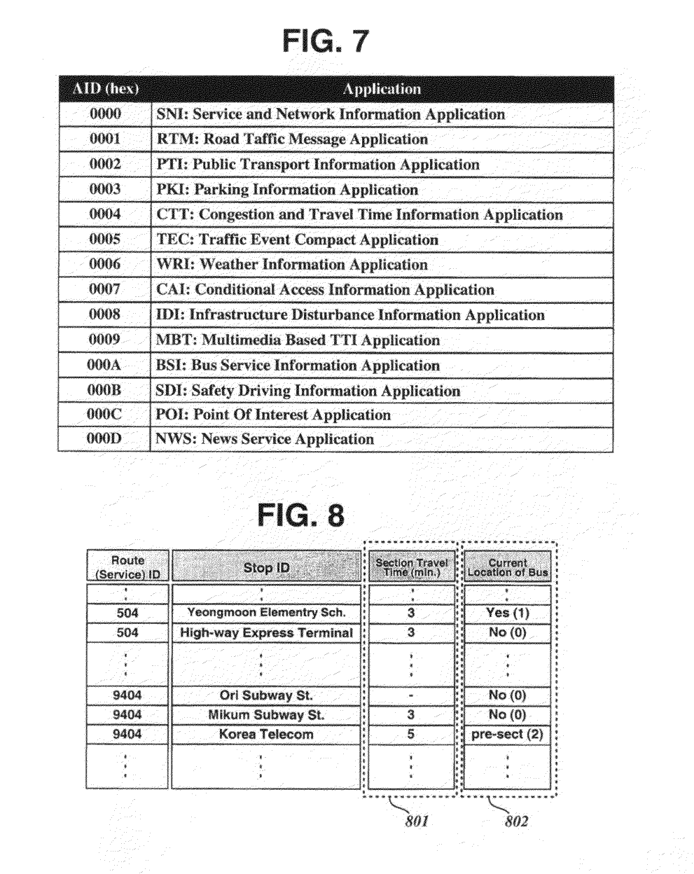

In this case, a plurality of decryption information is set in the CAS decoder 2 and application service identifying information to distinguish each of decryption information, e.g., an AID value according to the definition of FIG. 7, is set in association therewith. After setting the decryption information, reception and decoding of application information can be carried out and are described in detail below.

The tuner 1A resonates at signals of designated band transmitted by the application information providing server 100 (or a carrier that receives and transmits application information composed by the application information providing server 100) and the demodulator 1B demodulates and outputs resonated signals in a designated manner.

The TPEG decoder 3 first decodes input demodulation signals into data frames as shown in FIG. 4A and then extracts data of a service component frame whose SCID is specified as 00. The TPEG decoder 3 extracts guide elements of a service table composed as in FIG. 4C, constructs a service table guide, and from the constructed service table guide, provides the value of the encryption indicator 413 indicating encryption of individual application information (and an encryption method) for the CAS decoder 2 along with the identifier (AID) of the service.

Further, the TPEG decoder 3 searches the service table guide and checks the value of an SCID field 312 stored together with AID value (COID can be additionally designated) corresponding to the application service designated by the controller 5. After SCID value has been checked, the TPEG decoder 3 extracts a service component frame, where the checked SCID is located at the head position, from the data frames as shown in FIG. 4A and determines whether to immediately decode application information received being carried by the service component frame or to request decryption by delivering the application information to the CAS decoder 2.

Whether the TEPG decoder 3 immediately decodes and delivers received application information or provides received application information for the CAS decoder 2 is determined by whether the corresponding application information is received being encrypted. That is to say, if the encryption indicator 413 of a guide element of FIG. 4C received with respect to the corresponding application service indicates non-encryption (open information), received application information is decoded immediately and delivered to the controller 5, otherwise received application information is provided to the CAS decoder 2 together with AID of the service.

On the other hand, the TPEG decoder 3 extracts, from data extracted from a service component frame whose SCID is specified as 00, guide elements of a service table composed as shown in FIG. 4D and delivers the extracted decryption-related control data, e.g., a sync word (IMW) and a control word (CW) to the CAS decoder 2. At this time, as for the service component ID (SCID) recorded in the corresponding guide element, the TPEG decoder 3 searches the constructed service table guide for application service identifying information (AID) stored in the same guide element together with the SCID and delivers the searched application service identifying information to the CAS decoder 2 along with the decryption-related control data.

The CAS decoder 2 finds out from the encryption indicator and service identifier (AID) that the TPEG decoder 3 delivers whether application information of a particular service has been encrypted. If it is found encryption has been applied, the CAS decoder 2 reads out decryption-related control data stored and assigned along with the same application service identifier (AID) with respect to the application service and generates decryption keys based on assigned decryption information received previously from the controller 5. For example, if the assigned decryption information is a decryption function, a result value is obtained by using the control data (a sync word and a control word) as an input argument of the decryption function and the result value becomes a decryption key. The CAS decoder 2 then decrypts encrypted application information of the corresponding service received from the TPEG decoder 3 by applying a decryption key obtained in the above manner to a decryption method specified by the received encryption indicator and returns the decrypted application information to the TPEG decoder 3.

If decryption-related control data corresponding to the service identifier (AID) of application information received from the TPEG decoder 3 is not previously assigned, the CAS decoder 2 returns a value indicating decryption failure to the TPEG decoder 3 along with the corresponding service identifier (AID).

Meanwhile, if an application service is provided in the form of non-encrypted open information, the TEPG decoder 3 secondly decodes application information received being carried in a service component frame extracted from a first data frame decoding process and delivers the decoded information to the controller 5. For example, if the user requests BSI service from the terminal 200 and accordingly, the controller 5 applies a value of “0004” to the TPEG decoder 3 according to the definition shown in FIG. 7, the TPEG decoder 3, from the service table guide that the TPEG decoder 3 itself has constructed, reads the value of SCID field stored together in a guide elements of a service table, where the value of “0004” is stored, and decodes and delivers data in a service component frame, where the SCID value is located at the head position, to the controller.

The TPEG decoder 3 decodes and delivers application information received being decrypted from the CAS decoder 2 to the controller 5. If a return value informing of decryption failure is received from the CAS decoder 2, a service identifier (AID) received along with the return value is delivered to the controller 5 and ‘decryption failure’ is notified. The above is intended to inform the user through the LCD panel 6B that since an application service that the user wants to use is conditionally-accessible, a separate subscription or authentication procedure is necessary to use the service.

In another embodiment according to the present invention, instead of choosing an application service and delivering information provided by the service to the CAS decoder 2 or decoding the information and delivering the information to the controller 5, the TPEG decoder 3 either delivers application information received being encrypted from information of all application services included in the constructed service table guide to the CAS decoder 2 along with identifying information of each application service and obtains decrypted information, or decodes information of all open application services through the corresponding individual internal module (or a program routine) and delivers the decoded information to the controller 5. What follows below describes a method for using encrypted information provided through BSI service on the assumption that the user chooses the BSI service provided by a conditional reception method among various application services. As a matter of course, even if an application service provided by another conditional reception method is chosen, since the method can also be applied to an application service chosen in the same manner as described below, the claimed scope of the present invention is not limited to the cases of information types provided through application services described with embodiments below.

The user, to use BSI service, connects to a particularly designated server, receives decryption information of the service, and assigns the information to the CAS decoder 2. During the procedure, the user makes a contract for paid or free subscription by online or offline to use the corresponding service, undergoes user authentication through a server, and obtains the decryption function. At this time, a service identifier indicating BSI service, e.g., “000A” is stored together with the decryption function.

Meanwhile, the TPEG decoder 3 searches a service table guide constructed from data extracted from a service component frame whose SCID is specified as 00 for a table entry whose AID is recorded as “000A” and provides the value of encryption indicator in the searched entry for the CAS decoder 2 with AID value.

The TPEG decoder 3 extracts guide elements of a service table composed as shown in FIG. 4D from data extracted from a service component frame whose SCID is specified as 00 and from the extracted elements, delivers a sync word (IMW) and a control word (CW) belonging to an element in which the SCID value identified previously is recorded to the CAS decoder 2 together with the service identifier “000A”. The CAS decoder 2 then inputs the received sync word and control word to a decryption function stored in association with the same service identifier as a service identifier and obtains and stores the result value (a decryption key) in association with a received AID value. If multiple control words, e.g., two control words are received, the CAS decoder 2 inputs two input argument sets, each being paired with a sync word, into the decryption function and stores two decryption keys. The above procedure of generating and storing a decryption key is carried out each time the TPEG decoder 3 receives a sync word and a control word with respect to the corresponding service identifier from data extracted from a service component whose SCID is specified as 00 and provides the words.

The TPEG decoder 3, on the other hand, checks SCID value stored in an entry searched in the constructed service table guide and extracts, from a data frame received as shown in FIG. 4A, BSI application data of a service component frame where the SCID value is located at the head position and requests decryption while providing the BSI application data for the CAS decoder 2 together with the service identifier (AID).

The CAS decoder 2 decrypts received application data by using a result value (a decryption key) (a first decryption key if multiple keys exist) of a decryption function stored in association with a value identical to AID received together. In case of multiple decryption keys, a ‘use’ sign is marked on a used decryption key. A method in which the CAS decoder 2 decrypts by using a decryption key employs specification by using an encryption indicator received previously together with the same AID value. BSI application data decrypted according to the above method are returned again to the TPEG decoder 3 and the returned BSI data are decoded at the TPEG decoder 3 and provided to the controller 5 as BSI information.

In one embodiment according to the present invention, if the next BSI application data is received and multiple decryption keys are stored with respect to a BSI service and a ‘use’ sign is marked on a first decryption key, the CAS decoder 2 decrypts received BSI application data by using the next decryption key.

In another embodiment according to the present invention, under the condition that multiple control words have been received for a single service and multiple decryption keys have been generated, transition from a current decryption key to the next decryption key can be made when there is an instruction from the TPEG decoder 3. As a matter of course, the instruction of decryption key transition from the TPEG decoder 3 can be given based on information extracted from a service component frame whose received SCID is 00.

The controller 5 constructs a decoded information table with a structure as shown in FIG. 8 in the memory 4 by using decoded BSI information received from the TPEG decoder 3. FIG. 8 is a simplified example of a data storage structure, which shows that bus route IDs, bus stop IDs belonging to each route, required time 801 between bus stops on each route, and current location 802 of a bus are received and then stored. It is assumed that the above information is all provided from encrypted TPEG-BSI messages. The storage table illustrated in FIG. 8 can further include information elements which are not shown specifically (for example, route type, bus service company name, first and last service time, bus fare, and coordinate information of a bus stop) and decoded information can be stored with a structure different from FIG. 8. However, since the present invention is directed to how encrypted information provided from an application service is decrypted and provided for the user, specific description of the contents of information provided by an individual application service is not provided.

As shown in FIG. 8, in the column 802 of current bus location information, the value of 1 (which corresponds to Yes) is set when it is decoded that a bus in service is at the corresponding bus stop. The value of 2 (which corresponds to a preceding section) is set when it is decoded that a bus in service is located within a section where the bus stop becomes a destination. That is, the example of FIG. 8 shows a case that an identifier for a section where a starting point is ‘Mikum’ station and a destination is ‘Korea Telecom’ is received as location information of a bus in service and a value of 2 is set for the bus stop of ‘Korea Telecom’.

The controller 5, as for bus service information stored with a structure of FIG. 8, updates the corresponding information whenever new information is received from the application information providing server 100. The controller 5, instead of storing all the data received after decryption by the CAS decoder 2 and then decoding by the TPEG decoder 3 in the memory 4, can selectively store the data adjacent to the current location identified by the GPS module 8, e.g., data about bus stops within 1 km radius of the current location.

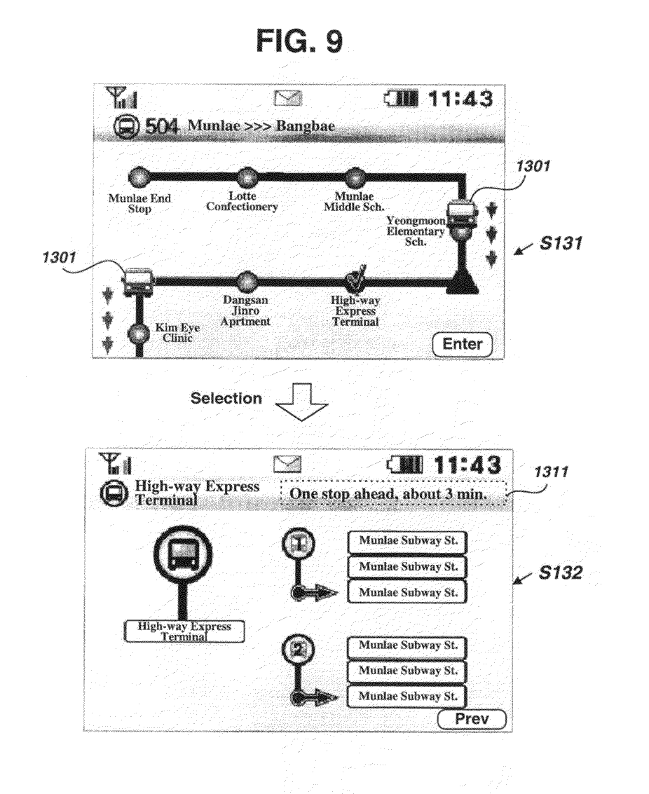

While received public transportation information is stored as above, if the user requests ‘public transportation information’ through the input device 9, the controller 5 displays a menu related to public transportation information at the user's choice on the LCD panel 6B. If the user selects a route number from a displayed menu through a relevant UI, the controller 5 searches the memory 4 and with respect to the corresponding route number, displays bus stop names on a screen together with a route ID and route information as shown in FIG. 9 by acquiring information about each bus stop stored as shown in FIG. 8, S131. In addition, the controller 5, by reading section transit time between individual bus stops from the corresponding column 801 of information table of FIG. 8, displays the section transit time in between bus stops on a screen.

With a user request or simultaneously with display S131 of bus stop names, by reading information about a current location of a bus in service on the corresponding route from the current location column 802 of information table of FIG. 8 and displaying a particular mark 1301 at the corresponding location on a screen, the user can be informed of a current location of a bus on a selected route.

On a route displayed on a screen, if the user selects a bus stop by properly using a move key equipped at the input device 9, the controller 5 displays on the screen S132 a variety of information that has been received for the bus stop, e.g., estimated arrival time of the corresponding route 1311 and information about each route passing through the bus stop. From the displayed information, the user can determine whether to use a route and estimate the associated waiting time.

According to a method described above, the user, by having decryption information necessary for an application service provided for a limited particular users as in a paid service, can receive application information provided through an application service of the conditional reception method and confirm the application information.

At least one embodiment of the present invention described in detail above, for part of a plurality of application services, part of an application service can be provided for charge by making only allowed users use. An application service provider, by providing a service for charge, can attempt to advance the quality of the service and information provided through the service, thus leading to the satisfaction of information users.

The foregoing description of a preferred embodiment of the present invention has been presented for purposes of illustration. Thus, those skilled in the art may utilize the invention and various embodiments with improvements, modifications, substitutions, or additions within the spirit and scope of the invention as defined by the following appended claims.

1. A method for encoding information, comprising:
encrypting application information that is to be provided through an application service;
creating a first service component frame including identification information of the application service and control data used for encryption of the application information and creating a second service component frame including the encrypted application information; and
organizing a data frame including the first service component frame and the second component frame.

2. The method of claim 1, wherein the first service component frame further includes an indicator indicating that the application information has been encrypted and indicating the encryption manner.

3. The method of claim 1, wherein the encrypting step encrypts the application information based on an output value obtained from a given function by applying the control data to the function as an input argument.

4. The method of claim 3, wherein the control data consists of a first word and a second word that are independent of each other.

5. The method of claim 4, wherein the second word comprises a plurality of words that function in same way but have mutually different applying-time points.

6. The method of claim 1, wherein value of a service component identifier identifying the first component frame is zero.

7. The method of claim 1, wherein the application information is one from among status information such as road obstacles, service information of a long-distance transportation means, parking lot information, road congestion information, weather information, bus service information, local area information, and news information.

8. A method for providing information for a user, comprising:
extracting a data frame from received signals;
extracting from the extracted data frame a first service component frame including information necessary for using information service, and extracting from the extracted first service component frame identification information of an application service and decryption-related control data; and
extracting from the extracted data frame a second service component frame including information of an application service identified by the identification information, and decrypting data of the extracted second service component frame based on the decryption-related control data.

9. The method of claim 8, wherein the extracting and decrypting step comprises:
receiving decryption information of the application service;
obtaining an output value with respect to the received decryption information by applying the decryption-related control data to the received decryption information as an input argument; and
decrypting data of the extracted second service component frame by using the obtained output value as a decryption key.

10. The method of claim 9, wherein a receiving route of the decryption information is different from that of the signals from which the data frame is extracted.

11. The method of claim 9, wherein the receiving step of the decryption information receives the decryption information after user authentication.

12. The method of claim 8, wherein the decrypting step decrypts the data of the extracted second service component frame by using a decrypting method determined based on an encryption indicator included in the extracted first service component frame.

13. The method of claim 8, wherein the control data consists of a first word and a second word that are independent of each other.

14. The method of claim 13, wherein the second word comprises a plurality of words that function in same way but have mutually different applying-time points.

15. The method of claim 8, wherein the first service component frame is a component frame to which zero is assigned as a value of a service component identifier.

16. The method of claim 8, further comprising decoding the decrypted data of the second service component frame.

17. The method of claim 8, wherein the information included in the second service component frame is one from among status information such as road obstacles, service information of a long-distance transportation means, parking lot information, road congestion information, weather information, bus service information, local area information, and news information.

18. A terminal apparatus of receiving information, comprising:
a demodulator configured to demodulate received signals to output a data frame;
a decoder configured to extract from the outputted data frame a first service component frame including necessary information for using information service and to extract from the extracted first service component frame identification information of application service and decryption-related control data; and
a decrypting unit configured to create a decryption key to be used for decrypting data of a second service component frame extracted from the data frame by using decryption information of the application service, and to decrypt data of the second service component by using the created decryption key.

19. The apparatus of claim 18, wherein the decoder further configured to decode data decrypted by the decrypting unit and to provide the decoded data for a controller as application information.

20. The apparatus of claim 19, wherein the controller is configured to store the application information in storage means and to output all or part of the stored information through an output device according to a given condition.

21. The apparatus of claim 18, wherein a receiving route of the decryption information is different from that of the signals from which the data frame is demodulated.

22. The apparatus of claim 18, wherein the decrypting unit is configured to decrypt the data of the second service component frame by applying the decryption key and a decrypting method determined based on an encryption indicator included in the first service component frame.
